(19) United States
(12) Patent Application Publication
(10) Pub. No.: US 2003/0141106 A1
(43) Pub. Date: Jul. 31, 2003

(54) Universal socket and component cartridge system

(76) Inventor: Thomas Michael Sievert, Lenexa, KS (US)

Correspondence Address: Thomas M. Sievert, 9405 Dice Lane, Lenexa, KS, 66215, US

(21) Appl. No.: 10/351,799

(22) Filed: Jan. 27, 2003

Related U.S. Application Data
(60) Provisional application No. 60/352,832, filed on Jan. 30, 2002.
(60) Provisional application No. 60/439,574, filed on Jan. 11, 2003.

(51) Int. Cl. H01R 13/60

(52) U.S. Cl. 174/260; 439/527

(57) ABSTRACT

An apparatus with a cavity, or socket, for holding and securing in place cartridge-like devices. Such apparatus, or socket, will contain components, such as electrical feed wires, antennae, a CPU chip, a RAM chip, microphones, speakers, a keypad, or a video screen which may be used interactively with the cartridge-like devices installed into the socket. The advantage of this process is that the cartridge-like devices, typically consumer electronic equipment, can be manufactured more economically with less components then a similar stand alone device that performs the same function. Also included is vent device designed in a cartridge form which can be installed into the apparatus or socket.

### FIELD OF THE INVENTION

The present invention relates generally to a socket type apparatus for holding or containing devices that have been manufactured in a cartridge type form. A vent type device is introduced as an example of the type of product that could be used as a cartridge for the socket type apparatus.

### BACKGROUND OF THE INVENTION

Consumer electronic devices are proliferating at a significant rate with the advent of computer chips, improved software technology and improved manufacturing techniques and capabilities. This proliferation of devices has caused problems: a taxing of the electrical supply in homes, the existence of unsightly wires, and an overcrowding of homes with numerous unsightly devices. What also occurs is that many of the consumer electronic devices contain specific components (i.e. electrical feed wires, outside casing materials, digital readouts, computer chips, etc.) that the devices all share in common. Many of the components of an individual device are still usable and in good working order when other parts of the device fails. When this occurs, the entire device is frequently disposed of, instead of being repaired, including tie components that are still in good working order; which is a waste.

Accordingly, a continuing search has been directed to the development of improved methods which can be used to manufacture consumer electronic devices to address problems associated with the proliferation of consumer electronic devices including the fact that such devices are disposed of when only a very few components of those individual devices fail; causing significant waste.

Recently, General Motors Corporation introduced the AUTOnomy concept of manufacturing automobiles. Under this concept, automobile manufacture is split between the building of a chassis and the building of interchangeable car bodies. In essence, the chassis can be connected with or attached to more than one car body. In addition, Hewlett Packard Corporation has developed print cartridges that contain important components from a printer. When the printer cartridge is disposed of, these components, such as the print head, are replaced while the majority of the printer is used for further work. Both the work of General Motors and the work of Hewlett Packard are examples of instances where a single device is split into more then one component or grouping of components resulting in manufacturing efficiencies overall cost reductions.

I respectfully disclose that I have not seen or heard of any other prior art with respect to this invention.

### SUMMARY OF THE INVENTION

According to the present invention an improved method has been developed for the manufacture of consumer electronic devices. This method is comprised of identifying those parts or components that are common to most or all consumer electronic devices and making them part of a universal socket. The parts of consumer electronic devices which are specific to the function of that device are then built or configured into cartridges which are insertable into a socket. The components in the socket combined with the components in the cartridge then work together to function as a unified product. The advantages of this approach are that cartridges may be built more economically than the stand-alone product since the cartridges contain fewer components; and, when the cartridges wear out and are of no use, they may be disposed of while the components included in the socket may be used in combination with other cartridges.

The specifications for this socket could be communicated to other manufacturers who would be allowed to develop cartridge type products that would fit into the socket—hence the name “Universal Socket and Component Cartridge System”.

The Cartridge System, to be truly “universal”, should be designed to hold a variety of cartridge type products as follows:

1. Socket cartridges could be developed as wall mounted recharging units for cellular phones.

2. Socket cartridges could be could be configured to work as an antenna for radio, cellular, or intercom reception. Specifically, a cartridge could be developed to use as a wireless access point for a wireless local area network (LAN), other sockets could be configured to operate as antenna to receive signals from that cartridge access point to operate other LAN based appliances.

3. Socket cartridges could be developed to operate as various types of wall mounted lighting.

4. Socket cartridges could be developed that would operate as wall mounted audio speakers.

5. Socket cartridges could be developed to contain rechargeable tools such as screwdrivers or hand drills.

6. Socket cartridges could be developed to function as a wall mounted video unit to project images against opposite sidewalls or screens.

7. Socket cartridges could be developed to function as a wall mounted unit for rechargeable appliances such as electric knives or toothbrushes.

8. Socket cartridges could be developed to serve as a “plug” or filler when the socket was not in use.

9. Socket cartridges could be developed with smoke detection or motion sensor capabilities (which could be useful if combined with access to phone lines).

The universal socket, to be truly “universal”, should be designed to function as follows:

1. Universal sockets could be connected to water and drainage, for a cartridge to make beverages.

2. Universal sockets could be directly wired to regular telephone service and cartridges developed with voice command/recognition dialing and speakerphone capabilities.

3. Universal sockets could be configured to work as an antenna and electrical feed for cartridges that had wireless web and e-mail access.

Here are some additional advantages of the universal socket system.

1. Unsightly electrical feed wires and antenna wires would be eliminated. (A cartridge could be built with a retractable extension cord for hand held units that required a direct electrical feed).

2. Since the socket could be connected to a wireless receiver or wire phone lines, devices inserted into the socket could be programmed using phone commands. Programming could occur remotely or internally from phones within the premises. Note that technology exists that will allow for data communication over the electrical lines. By connection with electrical service, the cartridge system may also be used as a communications conduit.

3. A socket could be designed to contain features such as a keypad (or voice operation/activation), speaker, microphone, video screen or plug in jack to perform all the functions of a communications device such as a stand alone telephone or to use such features for communication with an insertable cartridge.

4. The socket could be designed to work as an antenna, repeater or amplifier to send or receive signals for a variety of cellular/wireless applications. Wireless LAN systems could be developed.

5. The socket could contain memory and/or computer chips to work as a “smart” device in concert with Personal Computer based applications.

6. Since the cartridges would be sized to fit into a standardized socket, standardization of the manufacturing processes could be accomplished for the cartridges and manufacturing costs would be reduced.

7. Cartridges would be mounted into the walls freeing up room space.

8. The socket could be “stackable” and include a surge protector/circuit breaker. In addition, socket could contain an electrical socket for electrification of normal plug-in devices.

9. The socket could be built with a locking mechanism or cover to prevent theft of the cartridge. This could be a real advantage where cartridges are installed in places that are open to the publics such as in motels.

10. The socket approach would facilitate easy installation and removal of the cartridge. The cartridges could be easily replaced as they became worn out, required updating, or were otherwise no longer usable.

11. In general, since the functions of an electronic device would be performed by two devices—the cartridge and the socket—replacement of the cartridge would be less expensive then replacement of the entire electronic device—since the socket functions (power feed, antenna, etc.) would not be disposed of (The HP inkjet printer exemplifies this approach. A major portion of the printer device is replaced—the print head which is subject to significant wear and tear—each time the ink cartridge is replaced).

12. The tools or appliances would have a place that would be dedicated to storage for those items.

13. The cartridges could be moved between rooms as room functions changed. This could make certain aspects of home remodeling much easier.

14. A data signal repeater or signal amplifier could be made part of the universal socket to improve data or telecommunications signal reception and transmission in areas where transmission is not available or signals are weak.

15. The standardization of cartridge sizes could lead to marketing programs where a selection of cartridges was offered as product “bundles”. Product bundling offers an endless number of marketing opportunities.

Below is a list of items (most of which our household either owns or have considered purchasing) which could be modified to use as a cartridge type product for the universal socket system:

| | |
|---|---|
| 1. | AM/FM TV and Stereo Cassette Player |
| 2. | Battery powered Thermometer |
| 3. | Battery Storage Unit and Recharger |
| 4. | Body Fat Monitor |
| 5. | Carbon Monoxide Sensor |
| 6. | CD Player |
| 7. | CD Storage Case |
| 8. | Cordless Steam Iron |
| 9. | Dictaphone Voice Recording System |
| 10. | Digital Alarm Clock |
| 11. | Digital Blood Pressure Monitor |
| 12. | DVD/VCR Player |
| 13. | Electric Bug/Pest Terminator |
| 14. | Electric Tooth Brush |
| 15. | Hair Trimmer |
| 16. | Hand Held Electric Hair Dryer |
| 17. | Indoor/Outdoor Thermometer |
| 18. | Lava Lamp |
| 19. | Lighting System with Remote control dimmers |
| 20. | Mini Air Purifier |
| 21. | Mini Cigar Box Humidor |
| 22. | Mini Cofee/Cappuccino Maker |
| 23. | Mini Hand Vacuum |
| 24. | Motion Detector |
| 25. | Personal Computer (PC)/Printer/Related Peripherals |
| 26. | Rechargeable Electric Screwdriver |
| 27. | Rechargeable Flashlight |
| 28. | Rechargeable Hair Trimmer and Shaver |
| 29. | Rechargeable Knife |
| 30. | Remote Controls for Various Devices |
| 31. | Smoke Detector |
| 32. | Ventilator Unit |
| 33. | Video Camera |
| 34. | Wireless Headphones |
| 35. | Wireless Phones/Wireless Access Point/Wireless LAN |
| 36. | Wireless Remote Speakers |
| 37. | Wireless Residential Intercom Unit |

Probably the biggest market that the universal socket system would be the existing residential market. A problem would be how to get electrical feed to the System socket. This problem is a real opportunity.

The most accessible electrical feeds in any residence are the electric sockets located about 9″—18″ above floor level. The Universal Socket could be manufactured so that it could replace these electrical sockets. To do this, the hole that the electric socket fits in would be widened to fit the Universal Socket. The electric socket would be removed and the electrical feed that went into the electrical socket would be inserted into the Universal Socket to electrify the Universal Socket.

A very important point is that the Universal Socket could be configured so that it not only would only accept socket cartridges but would also have dual electrical inputs so that it could also operate as a standard electrical socket. In this manner you could have a universal socket hold cartridges and you would not lose the functionality of an electrical socket—which could be a major selling point. Alternatively, the cartridges could be configured to work as an electrical socket.

Sales of simple electrical sockets could be replaced by sales of universal sockets. Accordingly, all of the channels (home improvement stores, Wal-Mart, K-Mart, etc., commercial sellers) where electrical sockets are sold could be the target for the sale of the Universal Socket.

In addition, the universal socket would be configured so that it would be “stackable”. A larger hole could be made in the wall to fit in a “stack” (2 or more) of Universal Sockets. The individual sockets in the socket “stack” would plug into eachother so that the socket that initially accepted the electrical feed would electrify the other sockets in the stack. This way a “stack” of sockets could be installed at the same time. (Alternatively, the sockets could fit side by side along the floor line.)

Of course, a stack of sockets could have a significant electrical draw which could cause a fire hazard if wires became overloaded. To address this, and add additional functionality to the universal socket, it should be possible to install a circuit breaker/surge protector in the socket accepting the electrical feed. In this manner, if the electrical draw became too high, the circuit would be broken. As an advantage, the surge protector could protect the component cartridges from electrical surges or lightening strikes.

The process of removing an electrical socket (normally nailed to a stud), widening the hole for the Cartridge Socket (normally, cutting out a sheet rock section to fit between studs 16 inches on center), and re-installing a component cartridge system, or a socket “stack”, should be simple enough to be done by a homeowner handy with tools. In the alternative, an electrician should be able upgrade the sockets in a standard sized house fairly quickly.

In general, the configuration of a universal socket should be uniform. However, there may be more then one size to fit a “family” of different sized cartridges. It would also be good to design the sockets so that they were washable so that dust or food particles could be easily cleaned (this could be particularly helpful where food preparation utensils are utilizing the socket). Finally, it may be possible to incorporate some type of computer and/or memory “chip” in the universal socket to give the it some type of intelligent or interactive capacity or functionality. This could allow it to interact with cell phones, other sockets, and/or personal computers.

In addition to serving the commercial market, the universal socket would have commercial applications. For example, rechargeable power tools could be simultaneously recharged, stored, and locked up using the a universal socket with a security lock that was designed to lock in expensive cartridges for protection against theft or other type of loss.

The height of the socket installation could vary. A socket installation for holding rechargeable toothbrushes would be installed at eye level in a bathroom. Alternatively, an installation holding wireless speakers could be installed near the floor in a corner (to replace existing electrical sockets as mentioned above. Note that a socket installed in a wall that is part of the outside premises walls may interfere with the wall insulation. While this problem will likely be minor, in some cases it may be advisable to install the socket on the inside walls.)

In addition, more than one socket could be installed per room (as a product “stack” as mentioned above. In fact, in view of the variety of devices that have been, or will be, developed that could be modified to fit in the Cartridge System, it is likely that more then one socket would be used in a room.

In order to provide a workable example of a type of product that would be ideal for development as a cartridge, I have invented a garage ventilation device (vent device) which could be used for insertion as a cartridge into a universal socket.

At its core, the vent device is a simple fan. The fan motor will rotate the fan axle which drives the fan. Air will be drawn into the ‘intake duct’ in the side of the ventilation unit. The ‘air intake dam’ will guide the air, changing the flow direction from directly into the ‘air intake port’ to a flow that is transverse in the direction of the fan. After passing through the fan, the air will be directed past a heating element (optional) to a movable door that will re-direct the airflow from a transverse direction to a direction out of the fan casing.

The unit vent device may be comprised of one motor and one fan or one motor and a series of fans depending upon motor/airflow characteristics and airflow requirements. As an alternative embodiment, the vent device could be designed so the plane of rotation of the fan blades would be parallel to wall that the unit was installed in (the fan would pull air directly in and out of the garage—as opposed to; into the unit, across the body of the unit, and out). However, a problem with this approach (which could be overcome) is that the traditional motor/fan setup is ‘fat’—it may protrude significantly (keep in mind the width of a garage wall or an insulated door panel). As a result, there would be no room for some of the features. Besides, with the right motor, a series of 1½″ to 3½″ fan blades assembled as I have drawn would generate a very adequate airflow (note that insulated steel doors range from 1 1/2″ to 2− in thickness while the outside wall of an insulated garage would typically be about 4″ in thickness).

Following is a list of additional features that could be added to the vent device. The features could be included in certain versions of the device to build “standard” or “deluxe” versions of the unit to hit various price points or to segment the market for commercial or residential applications:

1. The vent device could have a timer which will turn the fan on for a specific period of time. This will be useful when the garage requires a one-time air evacuation.

2. The vent device could have a heating element to warm air in the garage in the winter. A manual, or mechanically driven, movable door could be incorporated into the unit which would adjust the air intake doors to pull air in from the outside or re-circulate air already in the garage (similar to a switch that performs the same function in a car).

3. Depending upon how the vent device radiates heat, and the insulation characteristics of the garage, it may be more effective to install two units on each side of the door to heat the garage more quickly.

4. A thermostat could be included in the vent device to measure the outside and inside garage air temperatures. Switches could turn the fan off/on depending upon the relative differences of the inside and outside air temperatures. In the summer I would use this feature to pull cool night air into the garage. The thermostat would also be used to regulate the functioning of the heater in the winter.

5. Intake and exhaust doors will cover the openings when the vent device is not operating. The doors will prevent insects, leaves, etc. from entering the garage and will also be designed to improve the outside appearance of the unit by covering the vent holes when the unit is not in operation. The vent doors, and the outside facing of the unit, should be designed to make the unit as invisible as possible.

6. The vent device could contain a humidistat. This could regulate humidity levels and automatically turn the unit on/off to adjust garage humidity levels relative to outside air levels. This feature could be important where moisture is a problem—Orlando or Houston, for example.

7. The part of the vent device that fits inside the garage wall or garage door panel (which should be the entire unit except the electrical feed) should slide in and out of the door easily. This would allow for the insertion of a ‘plug’ into the hole for long-term or permanent replacement of the unit.

8. A variety of filters could be attached to the vent device. This could be helpful in cases where the customer had allergies and required pollen filtration—or where a modified ‘clean room’ environment was required—such as where furniture polish was being applied, or vehicle parts spray-painted. If the right filter was used, and air was re-circulated inside the garage through the filter, you could have some really clean air—which is useful in numerous applications. In addition, this would be a good way to generate additional revenue selling filters.

9. The vent device could be programmable. It should be possible to have activation of the programs occur using a remote control. The unit could contain three programs, for example: a quick exhaust; a weekend program where the garage is heated throughout the day; and, a weekday program where the garage is heated only during a certain part of the day. It would be a major convenience to activate these programs using the same remote control that was used for the garage door opener. This would make it easier for the customer to look at an opener/vent installation as a complete package—along with a new insulated door—and “just buy the whole thing . . . ”.

10. The remote control function for both a garage door opener and the vent device could be integrated into a cellular phone. (Note that, aside from the remote controls TV and video applications, the garage door remote appears to be the most commonly used remote control device for home applications. The point is that the demand for a garage door remote has already been established. While remote control applications via phone exist, they have not achieved general acceptance being utilized by only the “early adopters”. This product approach has the potential to introduce remote control applications via cellular phone into the mainstream making it easier to introduce similar applications for other products or appliances.)

11. The vent device could have a “reverse” switch to change the direction of operation of the fan blades to allow it to work as either an intake fan or an exhaust fan. Because of this, one unit could be installed in one area of the garage and another unit could be installed in another area—for better airflow.

12. A very important feature would be to integrate the vent device in with the control system for the house or buildings' HVAC system. It may be possible to include control of the system in with the thermostat. This way it could be possible, for example, to keep the air conditioning off while the unit was pumping cool night air into the building.

13. A version of the vent device could be designed to sell as a component part of a window installation in either an outside wall or in a panel in a garage door. For example, it may be possible to sell a complete window section with the ventilation unit fully pre-wired and ready for installation. This would also be a way to sell windows.

While this invention has focused on development of a unit for ventilating the garage; it should be kept in mind that the unit may be suitable for other rooms such as the kitchen or the bedroom—virtually any place that a universal socket could be installed. Potential expansion of the utility of this device should be kept in mind as the product development process continues.

### BRIEF DESCRIPTION OF THE DRAWINGS

FIG. 1 is a cross sectional view of a universal socket installed between two studs or structural supports in the wall of a building.

FIG. 2 a cross sectional view of a cartridge type of devices suspended slightly above the universal socket. The universal socket is installed between two studs or structural supports in the wall of a building.

FIG. 3 is a frontal view of a cartridge installed inside of a universal socket. Also depicted is an electric wall socket that may be used to supply electricity to plug in type devices.

FIG. 4 is a frontal view of a cartridge installed inside of a universal socket. The socket is extended on one side to expose a surface area which may be used to contain control or plug-in type devices, a speaker(s), a microphone(s), a camera(s), or other type of device or control mechanism.

FIG. 5 is an overhead view of a vent device cartridge installed into a universal socket.

### DESCRIPTION OF THE PREFERRED EMBODIMENT(S)

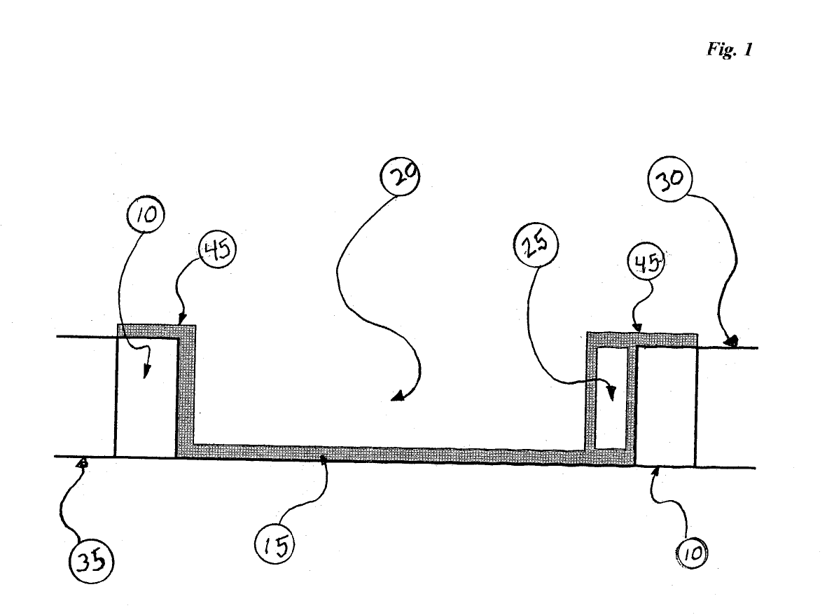

Referring to FIG. 1 of the drawings, the reference numeral 10 refers to studs or internal building supports. The reference numeral 15 refers to the universal socket which is mounted or affixed between the studs or building supports 10. The reference numeral 20 refers to the cavity which will optionally contain an interchangeable cartridge type device. The reference number 25 refers to a cavity which will contain items or devices that will serve to interact with the interchangeable cartridge type device such as RAM chips, a microphone, a CPU, electrical connectors, an antenna, speakers, a camera, etc. This cavity is located as shown for the purpose of illustration but may be located on the other (or left) side, top or bottom of the socket, or said items or devices may be embedded in the surface or walls of the cartridge. The final configuration and location of said items or devices will be determined by those skilled in the art and no further description is considered necessary. The reference number 30 and 35 refer to the surface area of the inside wall and the outside wall, respectively, of the building or structure that the universal socket is contained in. Note that top surface 45 of the socket is flush mounted against the inside wall 30 so as to protrude as little as possible away from that wall.

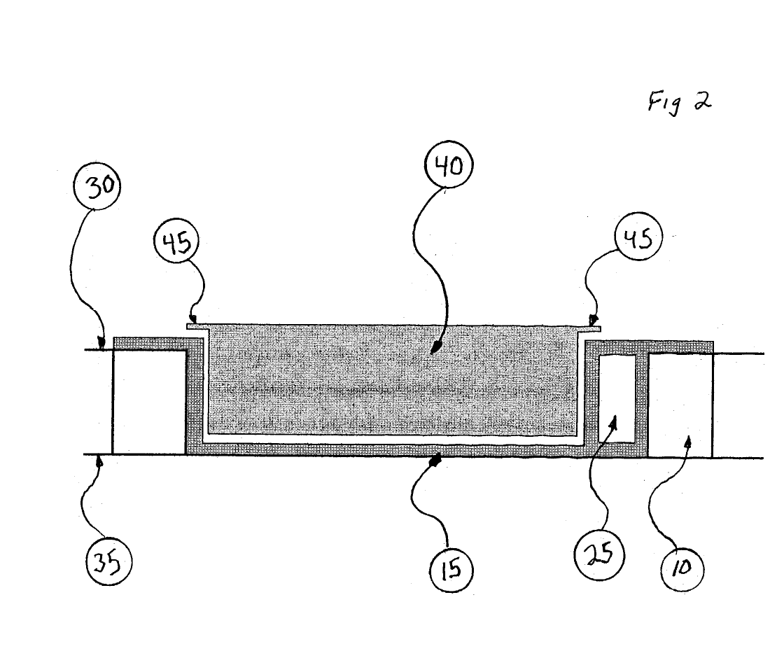

Referring to FIG. 2 of the drawings, all of the reference numerals are the same as described above with the exception of reference numeral 40. Reference numeral 40 is an interchangeable cartridge type device which is located, or inserted, in the cavity that comprises the universal socket 15. The interchangeable cartridge 40 is suspended slightly above the universal socket 15 in this figure to more clearly display how the interchangeable cartridge 40 would fit into the universal socket 15. Note that the lip of the top surface 45 of the universal socket 40 may, optionally, overlap the top of the universal socket 15 or the interchangeable cartridge 40 may fit inside the universal socket 15 so that the top of the interchangeable cartridge 40 does not protrude outside from the universal socket 15.

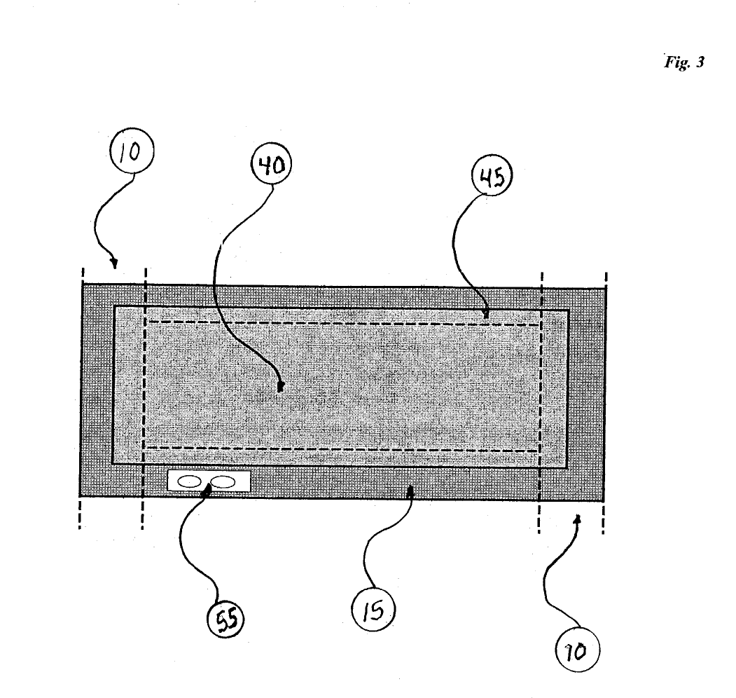

Referring to FIG. 3 of the drawings, depicted is a frontal view of an interchangeable cartridge which is installed into a universal socket. All of the reference numerals are the same as described in FIG. 1 with the exception of reference numeral 55. Reference numeral 55 is an optionally included electrical socket which may be used for providing electric power to plug-in electrical devices. This feature may be helpful where a universal socket replaces a plug-in socket in existing construction. Where this occurs, the features of a universal socket are available as well as the features of a plug-in socket.

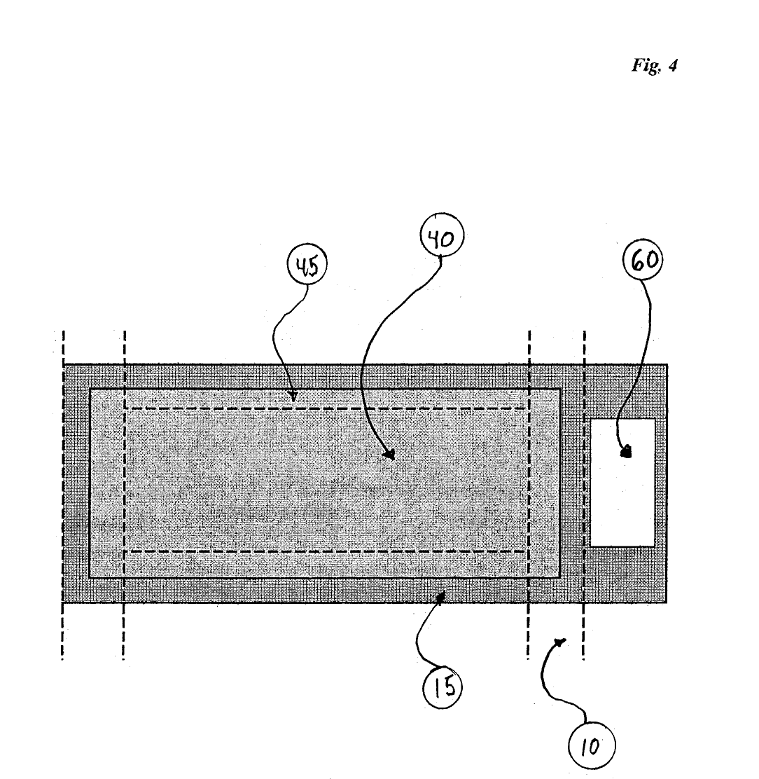

Referring to FIG. 4 of the drawings, depicted is a frontal view of an interchangeable cartridge which is installed into a universal socket. All of the reference numerals are the same as described in FIG. 1 with the exception of reference numeral 60. Reference numeral 60 is an optionally included section of the face or frontal view of the universal socket where a keypad, video screen, plug in jack, microphone, speaker and/or other type of input/output device may be optionally situated. Note that the right side of the universal socket has been elongated to include this section. The elongated section has been included on the right side, however, it may be included on the left side and/or, the top or bottom of the universal socket as determined by those skilled in the art of such detailed design.

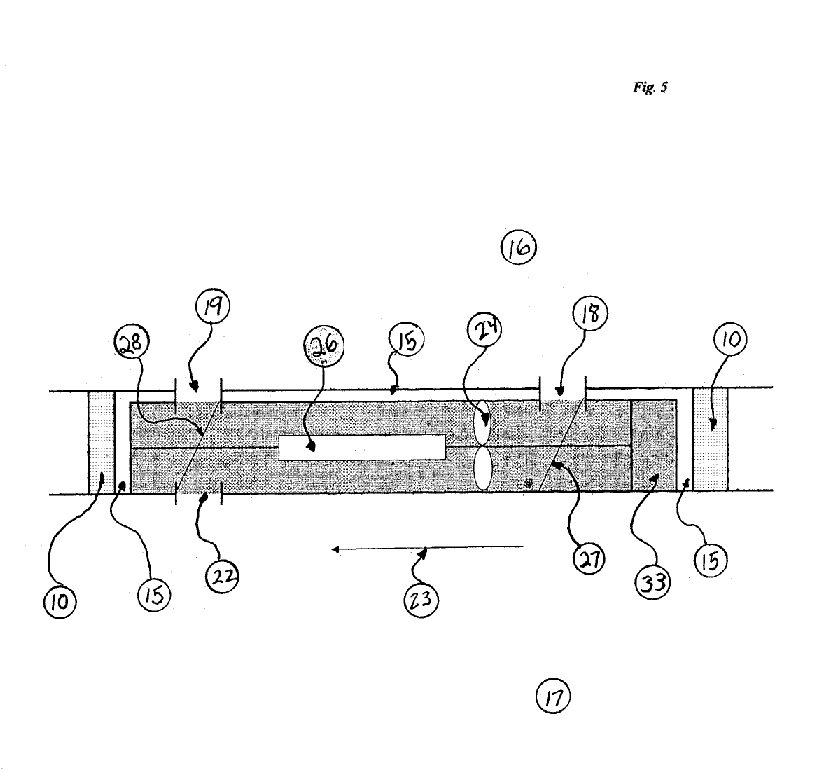

Referring to FIG. 5 of the drawings, depicted is an overhead view of a vent device which may is installed inside a universal socket 15 as a cartridge. This vent device would receive electrical power from contact with electrical feed wires that were part of the universal socket. Reference numeral 16 is to be considered the outside of the domicile; reference numeral 17 is to be considered the inside of the domicile. Note that in this figure the universal cartridge 15 has two optionally included openings 18 and 19 which may be used to vent fumes, a gas, or air (air). In this figure, the general movement of the air is to be considered moving in the direction noted on arrow 23 from opening 18 in the body of the universal socket, funneled or directed by a moveable door or air dam 27, past the fan blades 24, past the optionally included heating element 26, and directed into the building through opening 22 by a second moveable door or air dam 28. 33 is a cavity or compartment which will hold the fan motor and, optionally, other types of components, or parts of components, including a humidistat, an antennae for remote control operation, a thermostat. The final location and sizing of this cavity and the types of components included therein will be determined by those skilled in the art of such detailed design. Note that the universal socket 15 that holds the vent device cartridge is mounted or secured between two studs or building supports 10, as is the usual practice.

Having thus described the invention, what is claimed is:

1. An apparatus for removeably holding or containing at least one cartridge-type device which will be installed or affixed into a wall or solid partition of a building or structure comprising:
a cavity or indentation which will accept and hold said at least one cartridge-type device until such time as it is removed or replaced;
an outside casing of such a width so as to be insertable between construction studs or support beams commonly used in building construction, such studs or support beams installed in the standard or customary manner and with the customary spacings;
an assembly internal to the apparatus which will connect with an electrical power supply from an outside source;
an assembly internal to -the apparatus which will optionally connect the assembly which is connected to the electrical power supply with the at least one cartridge-type device.

2. The apparatus of claim 1 wherein including at least one microphone type device for accepting audio signals and transferring such signals through a connector-type assembly, which is optionally part of the apparatus of claim 1, into at least one cartridge-type device inserted into the apparatus of claim 1, and/or into data lines, telephone wires, wireless apparatus and antenna, or similar types of signal transmission media.

3. The apparatus of claim 1 wherein including at least one camera type device and/or video screen or display for photographing, accepting and/or displaying video signals or pictures and transferring such signals or pictures into or from a connector type assembly, which is optionally part of the apparatus of claim 1, into or from at least one cartridge-type device inserted into the apparatus of claim 1, and/or into or from data lines, telephone wires, wireless apparatus and antenna, or similar types of signal transmission media.

4. The apparatus of claim 1 wherein including at least one keypad type device for the purpose of keying in and transferring keyed data from the at least one keypad type device through a connector type assembly, which is optionally part of the apparatus of claim 1, into at least one cartridge-type device inserted into the apparatus of claim 1, and/or into data lines, telephone wires, wireless apparatus and antenna, or similar types of signal transmission media.

5. The apparatus of claim 1 wherein including at least one speaker type device for the purpose of broadcasting audio signals transmitted through a connector type of assembly, which is optionally part of the apparatus of claim 1, from at least one cartridge-type device inserted into the apparatus of claim 1, and/or from the apparatus of claim 1, and/or from data lines, telephone wires, wireless apparatus and antenna, or similar types of signal transmission media.

6. The apparatus of claim 1 wherein including at least one plug-in jack type device for the purpose of accepting a connection to a wire or cable, said wire or cable which is connected to a camera, video screen, keyboard, microphone, telephone, or other type of signal transmitting and/or receiving device, in order to communicate data or signals, emanating from said signal transmitting and receiving device, through a connector assembly, said connector assembly which is optionally part of the apparatus of claim 1, to or from at least one cartridge type device inserted into the apparatus of claim 1, and/or to or from data lines, telephone wires, wireless apparatus and antenna or similar types of signal transmission media.

7. The apparatus of claim 1 including at least one video screen or display for the purpose of displaying information, data or pictures that was transmitted by or as a result of the operation of the apparatus of claim 1, and/or transmitted by or as a result of the operation of at least one cartridge type device inserted into the apparatus of claim 1, and/or was transmitted to or from data lines, telephone wires, or wireless apparatus and antenna or similar types of signal transmission media.

8. The apparatus of claim 1 wherein including at least one computer memory type device such as a random access memory (RAM) chip or similar type of device, for the purpose of storing information or data that was created by, and/or will be used in the operation of, at least one cartridge type device inserted into the apparatus of claim 1, and/or was created by, and/or will be used in the operation of, the apparatus of claim 1, said information or data which is transmitted to or from the at least one memory type device, to or from said at least one cartridge type device, through a connector type assembly which is optionally part of the apparatus of claim 1.

9. The apparatus of claim 1 wherein including at least one computer processing type device, such as at least one central processing unit (CPU) chip, for the purpose of processing information or data that was created by, and/or will be used in the operation of, at least one cartridge type device inserted into the apparatus of claim 1, and/or was created by, and/or will be used in the operation of the apparatus of claim 1, said information or data transmitted between said at least one computer processing type device and said at least one cartridge type device through a connector type assembly which is optionally part of the apparatus of claim 1.

10. The apparatus of claim 1 wherein including at least one antenna type device for the purpose of transmitting data and/or information to and/or from at least one cartridge type device inserted into the apparatus of claim 1, and/or emanating to and/or from the apparatus of claim 1, said data and/or information to be transmitted between said cartridge type device and said antenna type device, through a connector type assembly which is optionally part of the apparatus of claim 1.

11. The apparatus of claim 1 wherein including at least one type of assembly that will transmit data and/or information emanating to or from at least one cartridge type device inserted into the apparatus of claim 1, and/or emanating to or from the apparatus of claim 1, to or from data lines, telephone wires, wireless apparatus and antenna, or similar types of signal transmission media, said data and/or information to be transmitted between said data lines, telephone wires, wireless apparatus and antenna or similar types of signal transmission media and said cartridge type device through a connector type assembly which is optionally part of the apparatus of claim 1.

12. The apparatus of claim 1 wherein including some or all of the components of claims 2, 3, 4, 5, 6, 7, 8, 9, 10 and 11configured in such a manner so that said components will function interactively, in order to perform some or all of the functions of a wireless or wireline telephone or telecommunications device, with or without a cartridge type device or devices inserted into the apparatus of claim 1.

13. The apparatus of claim 1 wherein including at least one circuit breaker and/or surge protection type of device for the purpose of protecting the apparatus of claim 1, and/or protecting the at least one cartridge type device inserted into the apparatus of claim 1, from electrical surges, lightening strikes or other types of electrical anomalies.

14. The apparatus of claim 1 wherein including at least one type of locking assembly or mechanism for the purpose of securing, locking in place, and/or stabilizing the at least one cartridge-type device inserted into the apparatus of claim 1.

15. The apparatus of claim 1 wherein including at least one type of assembly that will optionally connect to and drain fluids emanating from at least one cartridge type device inserted into the apparatus of claim 1, and/or emanating from the apparatus of claim 1, to fluid drainage lines or pipes located in the walls, supports, studs, partitions, or building media adjacent to or in the same area as the location of the apparatus of claim 1, said drainage assembly which is included to the apparatus of claim 1 that will connect to said fluid drainage lines or pipes through a connector type assembly which is optionally part of the apparatus of claim 1.

16. The apparatus of claim 1 wherein including at least one type of assembly that will optionally connect to and supply fluids to at least one cartridge type device inserted into the apparatus of claim 1, and/or connect to and supply fluids to the apparatus of claim 1, from fluid supply lines or pipes located in the walls, supports, studs, partitions, or building media adjacent to, or in the same area as the location of the apparatus of claim 1, said fluid supply lines or pipes connected to the fluid supply assembly through a connector type assembly which is optionally part of the apparatus of claim 1.

17. The apparatus of claim 1 wherein including at least one signal repeater and/or amplifier type device that will optionally connect to, and will be used in transmitting data and/or signals emanating to or from at least one cartridge type device inserted into the apparatus of claim 1, and/or emanating to or from the apparatus of claim 1, said assembly connecting said signal repeater and/or amplifier type device with said cartridge type device which is optionally part of the apparatus of claim 1.

18. The apparatus of claim 1 wherein including at least one electrical current connector type of assembly for the purpose of connecting at least two apparatus of claim 1 together in a series, so that each apparatus of claim 1 so connected together may supply, carry or transmit electrical current between each other from an outside electrical supply.

19. The apparatus of claim 1 wherein including at least one data transmission connector type of assembly, using wires or wireless apparatus and antenna, for the purpose of connecting at least two apparatus of claim 1 together in a series so that each apparatus of claim 1 so connected together may carry or transmit data or signals between each other.

20. The apparatus of claim 1 wherein including at least one electric plug-in socket and/or at least one optionally retractable electrical extension and/or, the apparatus of claim 1 optionally including at least one opening or vent for the purpose of venting gas from one side of the apparatus of claim 1 to the other side of the apparatus of claim 1.

21. A cartridge type apparatus for removeably installing into the apparatus of claim 1 for the purpose of venting or moving gas, such venting device comprising:
an outer casing which is configured to fit into the cavity of the apparatus of claim 1 as an interchangeable cartridge;
at least one fan or blowing type device connected to at least one motor type device used for rotating the at least one fan type device for the purpose of circulating a gas;
a connector type assembly for optionally connecting with data and/or electrical feed wires for the purpose of supplying electricity and/or data to the vent device for the purpose of operating the vent device

22. The apparatus of claim 21 wherein including at least one humidistat and/or at least one thermometer for the purpose of measuring the humidity and/or temperature on the inside or outside of the building that the apparatus of claim 21 is located in, for the purpose of regulating the operation of the apparatus of claim 21.

23. The apparatus of claim 21 wherein including removable filters for the purpose of filtering gas which is moved or vented by the operation of the apparatus of claim 21.

24. The apparatus of claim 21 wherein including moveable and/or non-moveable vent doors and/or moveable and/or non-moveable air dams for the purpose of directing the flow of gas during the venting operation occurring as a result of the operation of the apparatus of claim 21.

25. The apparatus of claim 21 wherein including an antennae and related device for the purpose of receiving signals or data transmitted to or from a remote control device, said remote control device optionally operating and/or monitoring the at least one fan motor installed in the apparatus of claim 21, and/or the at least one moveable vent doors installed in the apparatus of claim 21, and/or the at least one moveable air dams installed in the apparatus of claim 21, and/or the at least one humidistat installed in the apparatus of claim 21, and/or the at least one thermometer installed in the apparatus of claim 21, and/or the at least one heating element installed in the apparatus of claim 21.

26. The apparatus of claim 21 wherein including a device or switch which may be operated manually or by remote control to reverse the direction and/or to control the operating speed of the at least one fan installed in the apparatus of claim 21, and/or adjust the position of the at least one moveable doors and/or air dams installed in the apparatus of claim 21, and/or adjust the operations of the optionally installed heating element in the apparatus of claim 21.

27. The apparatus of claim 21 wherein including an apparatus which will be used to integrate the operations of the apparatus of claim 21 with the heating, ventilation and air conditioning system of the building or structure where the apparatus of claim 21 is located.
